(19) United States
(12) Patent Application Publication
(10) Pub. No.: US 2026/0074902 A1
(43) Pub. Date: Mar. 12, 2026

(54) Device, Storage Device and Method for Switching Encryption Algorithm

(71) Applicant: Samsung Electronics Co., Ltd., Suwon-si (KR)

(72) Inventors: Youngtak Noh, Suwon-si (KR); Sungho Yoon, Suwon-si (KR); Younsung Chu, Suwon-si (KR); Myeongjin Moon, Suwon-si (KR); Moon Chan Park, Suwon-si (KR); Yejin Yoon, Suwon-si (KR); Sunghyun Jin, Suwon-si (KR)

(21) Appl. No.: 19/325,110

(22) Filed: Sep. 10, 2025

(30) Foreign Application Priority Data
Sep. 12, 2024 (KR) 10-2024-0124744

(51) Int. Cl. H04L 9/16; G06F 8/65; G06F 21/57; H04L 9/32

(52) U.S. Cl. CPC H04L 9/16; G06F 8/65; G06F 21/572; H04L 9/3247; G06F 2221/033

(57) ABSTRACT

A device includes a memory and a processor configured to receive, from a host, a first signature that is based on a first cryptographic algorithm, a second signature that is based on a second cryptographic algorithm, and firmware, verify the first signature based on a first public key for decrypting the first signature and a hash value associated with the firmware, and write a second public key that is included in the firmware into the memory in response to successful verification of the first signature.

### CROSS-REFERENCE TO RELATED APPLICATION(S)

This U.S. non-provisional application claims priority under 35 USC § 119 to Korean Patent Application No. 10-2024-0124744, filed on Sep. 12, 2024, in the Korean Intellectual Property Office, the disclosure of which is herein incorporated by reference in its entirety.

### BACKGROUND

Firmware is a type of software embedded or stored in various hardware devices to control, operate, and manage the hardware devices. During firmware installation or updates, firmware may be verified to ensure integrity and reliability thereof.

A cryptographic device, such as a hardware security module (HSM), may verify firmware using an algorithm that is supported (or capable of being supported) by the device. However, when a new firmware verification algorithm is required to replace the existing firmware, it may be difficult for the cryptographic device to verify firmware using the new algorithm.

### SUMMARY

Example implementations provide a device, a storage device, and a method for switching an encryption algorithm.

According to an example implementation, a device includes a memory and a processor configured to receive, from a host, a first signature generated based on a first cryptographic algorithm, a second signature generated based on a second cryptographic algorithm, and firmware, verify the first signature based on a first public key for decrypting the first signature and a hash value for the firmware, and write, in response to successful verification of the first signature, a second public key that is included in the firmware into the memory.

According to an example implementation, a storage device includes a non-volatile memory configured to store a first signature generated based on a first cryptographic algorithm, a second signature generated based on a second cryptographic algorithm, and firmware, and a storage controller configured to verify the first signature based on a first public key for decrypting the first signature and a hash value for the firmware and update, in response to successful verification of the first signature, a second public key that is included in the firmware into the storage device.

According to an example implementation, a method of operating a device includes receiving, from a host, a first signature generated based on a first cryptographic algorithm, a second signature generated based on a second cryptographic algorithm, and firmware, verifying the first signature based on a first public key for decrypting the first signature and a hash value for the firmware, and writing, in response to successful verification of the first signature, a second public key that is included in the firmware into a memory.

### BRIEF DESCRIPTION OF DRAWINGS

FIG. 1 is a diagram illustrating an example of a storage system according to example implementations.

FIG. 2 is a diagram illustrating an example of a signature system according to example implementations.

FIG. 3 is a flowchart illustrating an example of a method of operating a signature system according to example implementations.

FIG. 4 is a diagram illustrating an example of a storage device according to example implementations.

FIG. 5 is a diagram illustrating an example of a storage device according to example implementations.

FIG. 6 is a diagram illustrating an example of a storage device according to example implementations.

FIG. 7 is a diagram illustrating an example of a storage device and a verify operation according to example implementations.

FIG. 8 is a diagram illustrating an example of a storage device and a verify operation according to example implementations.

FIG. 9 is a flowchart illustrating an example of a method of updating the second public key of a storage device according to example implementations.

FIG. 10 is a flowchart illustrating an example of a method of verifying firmware of a storage device according to example implementations.

FIG. 11 is a diagram illustrating an example of a storage device and a first public key invalidation operation according to example implementations.

FIG. 12 is a diagram illustrating an example of a storage device and a public key storage operation according to example implementations.

FIG. 13 is a diagram illustrating an example of a device according to example implementations.

FIG. 14 is a flowchart illustrating an example of a method of operating a device according to example implementations.

FIG. 15 is a flowchart illustrating an example of a method of operating a device according to example implementations.

FIG. 16 is a flowchart illustrating an example of a method of verifying a first signature and updating a public key of a device according to example implementations.

FIG. 17 is a flowchart illustrating an example of a method of verifying a second signature of a device according to example implementations.

### DETAILED DESCRIPTION

Hereinafter, example implementations will be described with reference to the accompanying drawings.

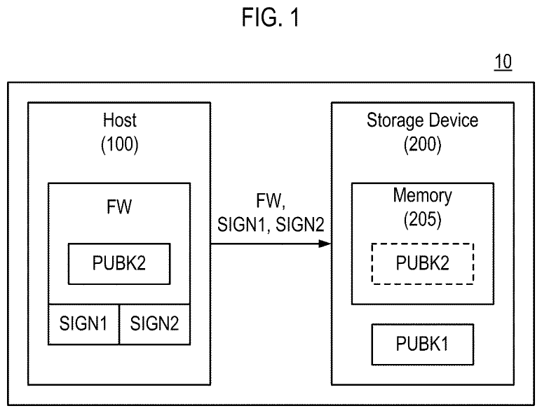

FIG. 1 is a diagram illustrating a storage system according to example implementations.

Referring to FIG. 1, a storage system 10 according to example implementations may include a host 100 and a storage device 200.

The host 100 may include one or more cores configured to process instructions. A core may be an independent and substantial processor, and may read and execute program instructions. As a non-limiting example, the host 100 may include an application processor, microprocessor, a central processing unit (CPU), a processor core, a multicore processor, a multiprocessor, an application-specific integrated circuit (ASIC), or a field programmable gate array (FPGA).

The host 100 may receive and store firmware FW from an external device. For example, the external device may be referred to as a firmware vendor, a firmware provider, or a manufacturer of the storage system 10.

The firmware FW may be embedded or stored in hardware and may be defined as software or a program for controlling, operating, and managing the storage device 200. The firmware FW may have a plurality of versions. A new version of firmware may be updated to the storage device 200 through a process such as firmware verification. After the update, a previous version of firmware (for example, previously installed firmware) may be replaced with the new version of firmware. A data file, including a specific version of the firmware FW, may be defined as a firmware image. The firmware image may take the form of a file used to update or modify the firmware FW. Hereinafter, the terms “firmware FW” and “firmware image” may be used interchangeably.

The firmware FW, received from the external device, may be signed through the external device and/or a hardware security module (HSM). In some implementations, the signed firmware may be firmware FW into or to which a first signature SIGN1, generated based on a first encryption algorithm, and a second signature SIGN2, generated based on a second encryption algorithm, are injected or added.

In the present application, the first cryptographic algorithm may be a non-post-quantum cryptography (non-PQC) algorithm, and the second cryptographic algorithm may be a PQC algorithm. The term “cryptographic algorithm” may be referred to as “signature algorithm,” “verification algorithm,” or the like.

For example, the first cryptographic algorithm may include Rivest-Shamir-Adleman (RSA), digital signature algorithm (DSA), elliptic curve digital signature algorithm (ECDSA), Edwards-curve digital signature algorithm (EdDSA), Diffie-Hellman, and/or elliptic curve cryptography (ECC).

For example, the second cryptographic algorithm may include lattice-based cryptography, code-based cryptography, multivariate polynomial cryptography, hash-based cryptography, homomorphic encryption, or the like. For example, the hash-based cryptography may include Leighton-Micali (LMS) algorithm, eXtended Merkle signature scheme (XMSS) algorithm, hierarchical signature scheme (HSS) algorithm, or the like.

Both the first and second cryptographic algorithms may commonly use a key pair including a private key and a public key. In some implementations, the storage device 200 may be configured to support both the first cryptographic algorithm and the second cryptographic algorithm.

In some implementations, the signed firmware may include a second public key PUBK2 that may be used for the second cryptographic algorithm, or may be firmware FW into which the second public key PUBK2 is injected.

The host 100 may transmit the received signed firmware, for example, firmware FW, first signature SIGN1, and second signature SIGN2, to the storage device 200.

The storage device 200 may be configured to process or store data in response to a request from the host 100. For example, the storage device 200 may include at least one of a solid state drive (SSD), an embedded memory, or a removable external memory. When the storage device 200 is an SSD, the storage device 200 may comply with the non-volatile memory express (NVMe) standard. When the storage device 200 is an embedded memory or an external memory, the storage device 200 may comply with the universal flash storage (UFS) or embedded multimedia card (eMMC) standard. Each of the host 100 and the storage device 200 may generate packets based on an adopted standard protocol and transmit the generated packets.

The storage device 200 may include a memory 205 storing the second public key PUBK2 used for the second cryptographic algorithm. In some implementations, the memory 205 may be allocated for the second public key PUBK2, or may store the first public key PUBK1 and the second public key PUBK2 together.

The storage device 200 may perform firmware verification for an update based on the received firmware FW. The firmware verification may be defined as a process of verifying the integrity and reliability of the firmware FW before installing the firmware image on the hardware. The firmware verification may be performed to verify whether the firmware FW has been tampered with or damaged, and whether the firmware has been provided from a trusted source. The firmware verification may be performed based on verifying the signature generated for the firmware FW. Therefore, hereinafter, verifying the signature generated for the firmware FW may be understood as verifying the firmware FW itself.

For example, the host 100 may transmit a download command and a commit command to the storage device 200 to update the received firmware FW to the storage device 200. When the host 100 transmits the download command, the storage device 200 may download a portion or all of the firmware image to the memory 205 within the storage device 200. When the firmware image includes a plurality of pieces, the host 100 may transmit individual download commands for each piece.

Then, when the host 100 transmits a commit command, the storage device 200 may perform firmware verification and commit on the downloaded firmware image. The storage device 200 may verify the firmware image. When the verification is successful, the storage device 200 may commit the firmware image to the storage device 200.

In some implementations, the storage device 200 may verify the first signature SIGN1 for the received firmware FW based on the first public key PUBK1 for decrypting the first signature SIGN1 and a hash value associated with the firmware FW. The verification of the first signature SIGN1 may be defined as an operation of verifying the first signature SIGN1 and the firmware FW based on the first cryptographic algorithm. For example, the storage device 200 may verify the first signature SIGN1 based on the first cryptographic algorithm for prestored (or held, or injected) first public key PUBK1 and the hash value.

When the verification of the first signature SIGN1 is successful, the storage device 200 may write (or program) the second public key PUBK2, included in the firmware FW, in the memory 205. For example, the success or failure of verification of the first signature SIGN1 may serve as a requirement for storing or updating the second public key PUBK2 in the storage device 200 (for example, the memory 205). Accordingly, only the first public key PUBK1 is present in the storage device 200 until the verification of the first signature SIGN1 is successful, and the storage device 200 may withhold storing the second public key PUBK2, received from the host 100, in the memory 205.

When the second public key PUBK2 is written in the memory 205 due to the successful verification of the first signature SIGN1, the update of the second public key PUBK2 for the second cryptographic algorithm is completed. When the verification of the first signature SIGN1 is successful, the storage device 200 may download the signed firmware. In addition, the storage device 200 may perform the second cryptographic algorithm based on the second public key PUBK2 written in the memory 205.

When the verification of the first signature SIGN1 fails, the storage device 200 may discard the firmware FW. Also, the storage device 200 may transmit an error message, corresponding to the failure of the verification of the first signature SIGN1, to the host 100.

After the successful verification of the first signature SIGN1, the storage device 200 may verify the second signature SIGN2 based on the second public key PUBK2 written in the memory 205 and the hash value. For example, the storage device 200 may verify the second signature SIGN2 based on the second cryptographic algorithm for the second public key PUBK2 written in the memory 205 and the hash value.

When the verification of the second signature SIGN2 is successful, the storage device 200 may update the previously installed firmware FW to the received firmware FW.

According to example implementations, the storage system 10 enables switching from an existing cryptographic algorithm, supported by firmware verification and update, to a new cryptographic algorithm.

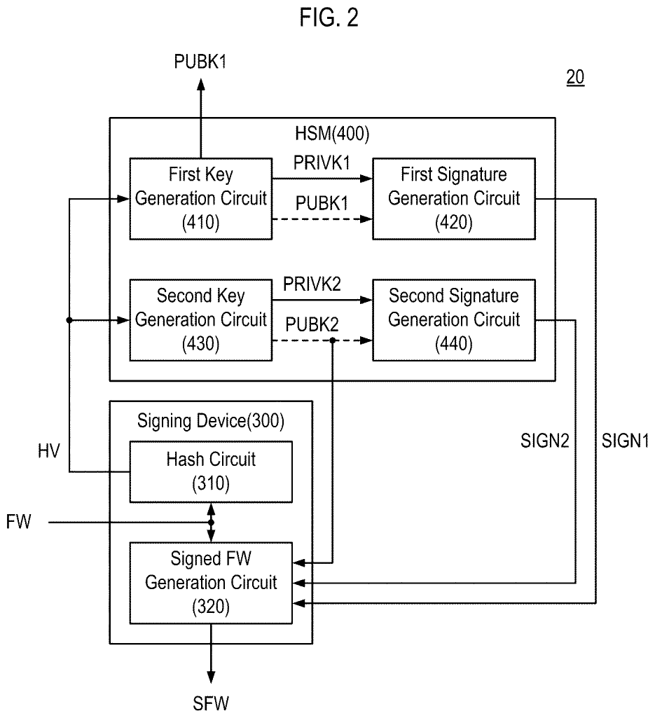

FIG. 2 is a diagram illustrating a signature system according to example implementations.

Referring to FIG. 2, a signature system 20 according to example implementations may receive or obtain firmware FW and generate signed firmware from the firmware FW. The firmware FW is a signature target and therefore may be regarded as a plaintext. The signature system 20 may be implemented as a computing system. For example, each of the components included in the signature system 20 may be implemented by one or more hardware modules, one or more software modules, one or more cores or processing units, and/or combinations thereof.

The signature system 20 may include a signing device 300 and an HSM 400. The signing device 300 may include a hash circuit 310 and a signed firmware generation circuit 320. The HSM 400 may include a first key generation circuit 410, a first signature generation circuit 420, a second key generation circuit 430, and a second signature generation circuit 440.

For example, the signing device 300 may correspond to or be included in the above-mentioned firmware vendor. Alternatively, the signing device 300 may correspond to or be included in the above-mentioned host.

The signing device 300 may include a hash circuit 310 and a signed firmware generation circuit 320. The hash circuit 310 may be configured to receive firmware FW and generate a hash value HV based on a hash algorithm (or a hash function) taking the received firmware FW as an input. Therefore, the hash value HV can be associated with the received firmware FW. As well known in the art, the hash value HV may also be referred to as a digest representing an output of the hash algorithm. For example, the hash function may be a secure hash algorithm KECCAK (SHAKE). SHAKE-256, SHAKE-128, or the like, may be used as the hash function. The hash circuit 310 may transmit a generated hash value HV to the HSM 400.

The HSM 400 may generate signatures through different cryptographic algorithms (for example, a first cryptographic algorithm and a second cryptographic algorithm) based on the received hash value HV.

The first key generation circuit 410 may be configured to generate a key pair (for example, a first private key PRIVK1 and a first public key PUBK1) based on the first cryptographic algorithm. As described above, the first key generation circuit 410 may generate a key pair based on a non-PQC algorithm.

The first key generation circuit 410 may transmit the first public key PUBK1 to the first signature generation circuit 420, the signature device, and/or the above-described storage system.

The first signature generation circuit 420 may be configured to receive the first private key PRIVK1 generated from the first key generation circuit 410 and to generate a first signature SIGN1 for the hash value HV based on the received first private key PRIVK1 and the first cryptographic algorithm. In some implementations, the first signature generation circuit 420 may receive the first public key PUBK1 and generate the first signature SIGN1 based on the first private key PRIVK1, the first public key PUBK1, and the first cryptographic algorithm. The first signature generation circuit 420 may transmit the generated first signature SIGN1 to the signed firmware generation circuit 320.

The second key generation circuit 430 may be configured to generate a key pair (for example, a second private key PRIVK2 and a second public key PUBK2) based on the second cryptographic algorithm. As described above, the second key generation circuit 430 may generate a key pair based on a PQC algorithm.

The second key generation circuit 430 may transmit the second public key PUBK2 to the signed firmware generation circuit 320.

The second signature generation circuit 440 may be configured to receive the second private key PRIVK2 generated from the second key generation circuit 430 and to generate a second signature SIGN2 for the hash value HV based on the received second private key PRIVK2 and the second cryptographic algorithm. In some implementations, the second signature generation circuit 440 may receive the second public key PUBK2 and generate the second signature SIGN2 based on the second private key PRIVK2, the second public key PUBK2, and the second cryptographic algorithm. The second signature generation circuit 440 may transmit the generated second signature SIGN2 to the signed firmware generation circuit 320.

The signed firmware generation circuit 320 may be configured to receive the firmware FW, the second public key PUBK2, the first signature SIGN1, and the second signature SIGN2, and to generate signed firmware based on the received data. In some implementations, the signed firmware SFW may include firmware FW including (or injected with) the second public key PUBK2, the first signature SIGN1, and the second signature SIGN2. The signed firmware generation circuit 320 may transmit the signed firmware SFW to the above-described storage system (for example, a host).

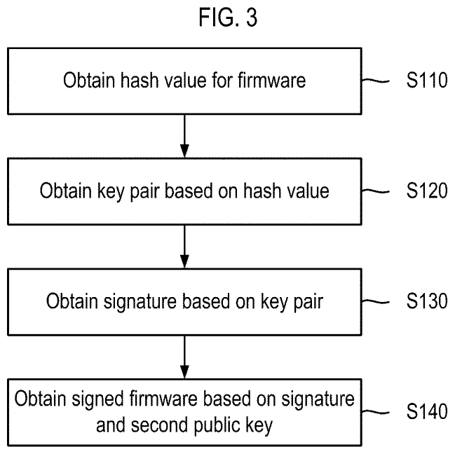

FIG. 3 is a flowchart illustrating a method of operating a signature system according to example implementations.

Referring to FIG. 3, in some implementations, in operation S110, the signature system may obtain a hash value for firmware.

In operation S120, the signature system may obtain a key pair based on the hash value obtained in operation S110. For example, operation S120 may be performed based on a first cryptographic algorithm and/or a second cryptographic algorithm. The key pair may include a private key and a public key corresponding to each cryptographic algorithm.

In operation S130, the signature system may obtain a signature based on the key pair obtained in operation S120. For example, operation S130 may be performed based on the first cryptographic algorithm and/or the second cryptographic algorithm.

In operation S140, the signature system may obtain signed firmware based on the second public key obtained in operation S120 and the signatures obtained in operation S130. For example, the signature system may inject the second public key into the firmware and obtain the firmware, the first signature, and the second signature as signed firmware.

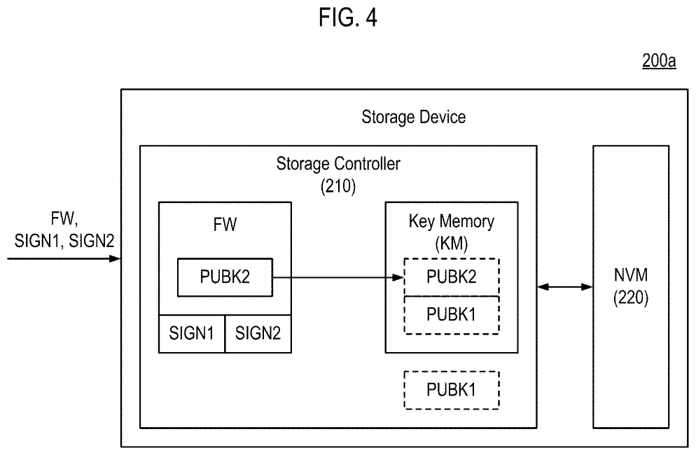

FIG. 4 is a diagram illustrating a storage device according to example implementations.

Referring to FIG. 4, a storage device 200a according to example implementations may include a storage controller 210 and a non-volatile memory 220.

The storage controller 210 may be configured to control the overall operation of the storage device 200a. For example, the storage controller 210 may store (or write or program) data in the non-volatile memory 220 or read data stored in the non-volatile memory 220 and transmit the read data to the host in response to a request or command from a host.

The non-volatile memory 220 may include a flash memory, a magnetic RAM (MRAM), a spin-transfer torque MRAM, a conductive bridging RAM (CBRAM), a ferroelectric RAM (FeRAM), a phase RAM (PRAM), a resistive memory, and various other types of memory. For example, when the non-volatile memory 220 is a flash memory, the flash memory may include a 2D NAND memory array or a 3D (or vertical) NAND (VNAND) memory array.

In some implementations, the storage controller 210 may include a key memory KM. The key memory KM may store a second public key PUBK2. For example, the key memory KM may be a one-time programmable (OTP) memory such as an anti-fuse array.

In some implementations, the key memory KM may be provided inside the storage controller 210, as illustrated.

In some implementations, the storage controller 210 may receive signed firmware from the host (for example, firmware FW including the second public key PUBK2), a first signature SIGN1, and a second signature SIGN2. The storage controller 210 may verify the first signature SIGN1 based on a pre-injected first public key PUBK1 and a hash value of the firmware FW. When the verification of the first signature SIGN1 is successful, the first signature SIGN1, the second signature SIGN2, and the firmware FW may be written in the non-volatile memory 220. The non-volatile memory 220 may store the first signature SIGN1, the second signature SIGN2, and the firmware FW based on the successful verification of the first signature SIGN1.

Alternatively, when the verification of the first signature SIGN1 fails, the storage controller 210 may discard the firmware FW, the first signature SIGN1, and the second signature SIGN2.

In some implementations, the first public key PUBK1 may be prestored in the key memory KM or stored in another memory, not illustrated, included in the storage controller 210 other than the key memory KM.

In some implementations, when the verification of the first signature SIGN1 is successful, the storage controller 210 may update the second public key PUBK2 included in the firmware FW to the storage device 200a. For example, the storage controller 210 may write the second public key PUBK2 in the key memory KM. Writing the second public key PUBK2 in the key memory KM may complete the update of the second public key PUBK2.

When the update of the second public key PUBK2 is completed, the storage controller 210 may perform firmware verification based on the second encryption algorithm instead of the first encryption algorithm. For example, after the update of the second public key PUBK2, the storage controller 210 may verify the firmware FW using the second encryption algorithm.

In some implementations, for signed firmware including the first signature SIGN1 and the second signature SIGN2 received from the host, when the verification of the first signature SIGN1 is successful, the storage controller 210 may perform verification of the second signature SIGN2 based on the second encryption algorithm.

In some exemplary implementations, for signed firmware including the second signature SIGN2 received from the host, the storage controller 210 may perform verification of the second signature SIGN2 based on the second encryption algorithm.

The storage device 200a according to example implementations have been described. The storage device 200a may enable switching from an existing supported encryption algorithm to a new encryption algorithm by updating the public key for the new encryption algorithm. After the switching, the storage device 200a may verify firmware using the new encryption algorithm.

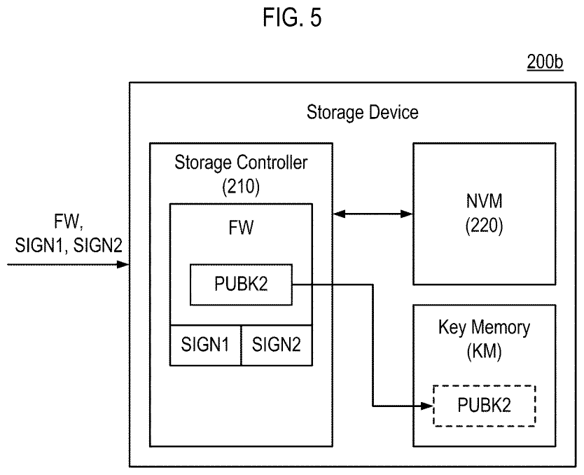

FIG. 5 is a diagram illustrating a storage device according to example implementations. Hereinafter, detailed descriptions of content overlapping with those of FIG. 4 will be omitted.

Referring to FIG. 5, a storage device 200b according to example implementations may include a storage controller 210, non-volatile memory 220, and key memory KM. Unlike the storage device of FIG. 4 with the key memory KM provided within the storage controller 210, in the storage device 200b of FIG. 5, the key memory KM may be provided externally to the storage controller 210. The key memory KM may be electrically connected to the storage controller 210.

The storage controller 210 may write a second public key PUBK2, included in the firmware FW, in the key memory KM when the verification of the first signature SIGN1 is successful.

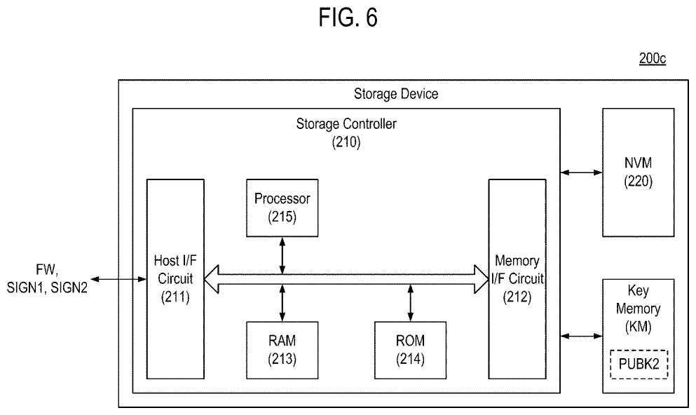

FIG. 6 is a diagram illustrating a storage device according to example implementations. For ease of description, an example is provided in which a key memory KM is provided and connected externally to a storage controller 210 as illustrated in FIG. 5, but example implementations are not limited thereto. For example, the key memory KM may also be provided inside the storage controller 210.

Referring to FIG. 6, a storage device 200c according to example implementations may include a storage controller 210, a non-volatile memory 220, and the key memory KM. The storage controller 210 may include a host interface circuit 211, a memory interface circuit 212, a random access memory (RAM) 213, a read-only memory (ROM) 214, and a processor 215.

The host interface circuit 211 may be configured to transmit and receive data to and from a host. For example, the host interface circuit 211 may receive a command and/or data to be stored in the storage device 200c from the host. Also, the host interface circuit 211 may transmit a response to a command or data read from the storage device 200c to the host.

The memory interface circuit 212 may transmit data to be written in the non-volatile memory 220 or the key memory KM, or receive data read from the non-volatile memory 220. The memory interface may be implemented to comply with a standard protocol such as Toggle or ONFI.

The RAM 213 may temporarily store data used or processed by the processor 215. For example, the RAM 213 may temporarily store data read from the ROM 214 or non-volatile memory 220, or may temporarily store data to be written in the ROM 214 or non-volatile memory 220. Also, the RAM 213 may temporarily store one or more instructions to be executed by the processor 215. For example, the RAM 213 may include a volatile memory such as a dynamic RAM (DRAM) or a static RAM (SRAM).

The ROM 214 may non-volatilely store firmware FW to be executed by the processor 215. For example, the ROM 214 may store signatures for the firmware FW (for example, a first signature SIGN1 and a second signature SIGN2) in addition to the firmware FW. Prestored firmware (or running firmware) may be configured to be verifiable based on the first cryptographic algorithm and the second cryptographic algorithm.

In some implementations, the ROM 214 may store an instruction or code for operating the first cryptographic algorithm and the second cryptographic algorithm.

The processor 215 may execute one or more instructions to perform operations for controlling the storage device 200c. For example, the processor 215 may be integrated into a single chip or a single die. For example, the processor 215 may be integrated into two or more chips included in a single package.

In some implementations, the processor 215 may receive the first signature SIGN1, second signature SIGN2, and firmware FW from the host through the host interface circuit 211. The processor 215 may read the first public key PUBK1 prestored in the storage device 200c and apply a hash algorithm to the firmware FW to obtain a hash value for the firmware FW.

The processor 215 may verify the first signature SIGN1 based on the first public key PUBK1 and the hash value. For example, the processor 215 may verify the first signature SIGN1 through the first cryptographic algorithm for the first public key PUBK1 and the hash value.

When the verification of the first signature SIGN1 is successful, the processor 215 may write the second public key PUBK2, included in the firmware FW, in the key memory KM through the memory interface circuit 212. Alternatively, when the verification of the first signature SIGN1 is successful, the processor 215 may store (or download) the first signature SIGN1, the second signature SIGN2, and the firmware FW in the nonvolatile memory 220.

After the second public key PUBK2 is written in the key memory KM (for example, after the update of the second public key PUBK2 is completed), the processor 215 may perform booting or secure booting for firmware. Alternatively, the processor 215 may update the previously installed firmware or currently running firmware to new firmware. The firmware update may be performed based on a download command and a commit command received from the host.

In some implementations, when booting, securely booting, or updating the firmware, the processor 215 may verify the second signature SIGN2 based on the second public key PUBK2 and the hash value. When the verification of the second signature SIGN2 is successful, the processor 215 may update the previously installed firmware to new firmware. The processor 215 may store new firmware based on the firmware update in the nonvolatile memory 220.

In some implementations, when the verification of the second signature SIGN2 is successful, the processor 215 may invalidate the first public key PUBK1.

The processor 215 may perform other operations of the storage controller 210 according to example implementations.

The storage device 200c according to some implementations has been described. The storage device 200c may enable switching from an existing cryptographic algorithm, supported by firmware verification and update, to a new cryptographic algorithm by updating the public key for the new cryptographic algorithm.

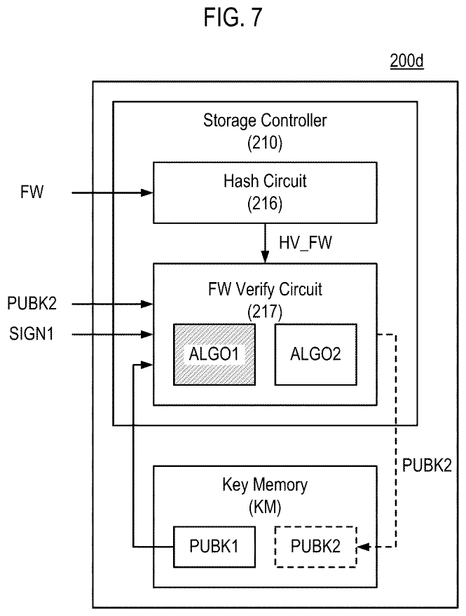

FIG. 7 is a diagram illustrating a storage device and a verify operation according to example implementations. Hereinafter, for brevity of the drawing, the first public key PUBK1 is illustrated as being stored in the key memory KM, but example implementations are not limited thereto. For example, the first public key PUBK1 may be stored in another memory within the storage device 200d other than the key memory KM.

Referring to FIG. 7, a storage device 200d according to example implementations may include a storage controller 210 and a key memory KM, and the storage controller 210 may include a hash circuit 216 and a firmware verify circuit 217.

The hash circuit 216 may be configured to receive firmware FW and generate a firmware hash value HV_FW from the firmware FW based on a hash algorithm. The hash circuit 216 may transmit the firmware hash value HV_FW to the firmware verify circuit 217.

The firmware verify circuit 217 may be configured to verify the firmware FW through a cryptographic algorithm for a signature. In some implementations, the firmware verify circuit 217 may receive the first signature SIGN1, the first public key PUBK1, the second public key PUBK2, and the firmware hash value HV_FW. For example, the first public key PUBK1 may be prestored in the key memory KM. The firmware verify circuit 217 may verify the first signature SIGN1 through a first cryptographic algorithm ALGO1 for the first public key PUBK1 and the firmware hash value HV_FW.

When the firmware verification is successful, the firmware verify circuit 217 may transmit the second public key PUBK2 to the key memory KM. Storing the received second public key PUBK2 may complete the update of the second public key PUBK2.

The storage device 200d according to example implementations may check the integrity of the firmware FW by performing first verification on the first signature SIGN1 generated for the firmware FW through the first cryptographic algorithm ALGO1. The first signature SIGN1 is also generated for the firmware FW itself, so that the integrity of the firmware FW itself may be ensured by verifying only the integrity of the first signature SIGN1. The storage device 200d may update the second public key PUBK2 within the firmware FW to the storage device 200d only when the integrity is checked based on the first verification, allowing only the secure and reliable second public key PUBK2 to be updated into the storage device 200d.

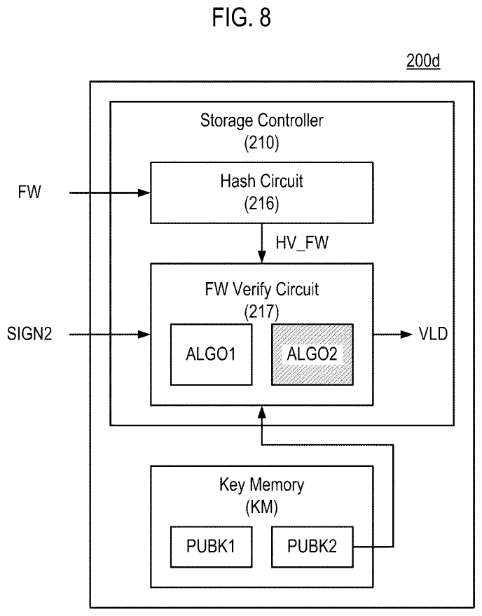

FIG. 8 is a diagram illustrating a storage device and a verify operation according to example implementations.

Referring to FIG. 8, a firmware verify circuit 217 of a storage device 200d according to example implementations may receive a second signature SIGN2, a second public key PUBK2, and a firmware hash value HV_FW. For example, the second public key PUBK2 may be stored in a key memory KM through an update. The firmware hash value HV_FW may be the same as that of FIG. 7, or may be a new hash value generated by the hash circuit 216 for another version of the firmware (for example, firmware to be updated). Another version of the firmware may be firmware for which the first signature SIGN1 and the second signature SIGN2 are generated according to the above-described implementations, or may be firmware for which only the second signature SIGN2 is generated.

The firmware verify circuit 217 may verify the second signature SIGN2 through the second cryptographic algorithm ALGO2 for the second public key PUBK2 and the firmware hash value HV_FW. When the firmware verification is successful, the firmware verify circuit 217 may generate validity information VLD. The validity information VLD may be information indicating that the firmware FW was generated from a trusted source. Also, the firmware verify circuit 217 may update previously installed firmware with a different verified version of the firmware.

The storage device 200d according to example implementations may perform firmware verification using the second cryptographic algorithm ALGO2, instead of the existing first cryptographic algorithm ALGO1, using the updated second public key PUBK2.

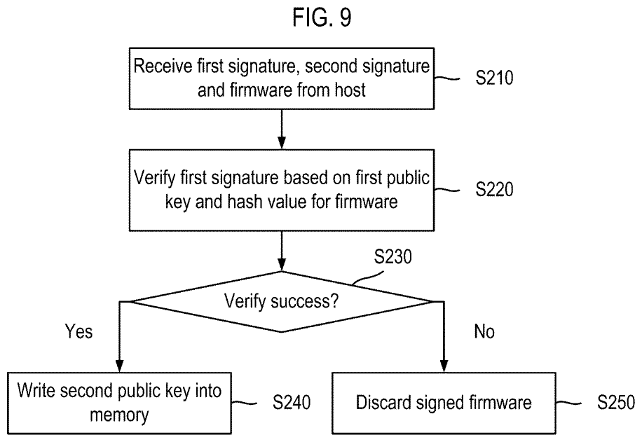

FIG. 9 is a flowchart illustrating the method of updating the second public key of a storage device according to example implementations.

Referring to FIG. 9, in operation S210, the storage device may receive a first signature, a second signature, and firmware as signed firmware from a host.

In operation S220, the storage device may verify the first signature based on a first public key and a hash value of the firmware. The first cryptographic algorithm may be used to verify the first signature.

In operation S230, the storage device determines whether the verification is successful.

In some implementations, when the first cryptographic algorithm is RSA, the storage device may decrypt the first signature using a first public key and compare a decrypted hash value with a firmware hash value. The storage device may determine that the verification of the first signature is successful when the decrypted has value and the firmware hash value are the same.

In some implementations, when the first cryptographic algorithm is ECDSA, an elliptic curve will be used in a verification process. When a signature (r, s) of ECDSA are defined as a first signature, the storage device may calculate a modular inverse of s and calculate u1 and u2 based on the modular inverse. The storage device may calculate the coordinates (x, y) on the elliptic curve based on u1, u2, and the first public key, and finally determines that the verification is successful when x mod n (where n is the order of the elliptic curve) is equal to r. The values u1 and u2 are intermediate values known in the art and used for signature verification of ECDSA.

Alternatively, when the storage device uses another non-PQC algorithm as the first cryptographic algorithm instead of RSA or ECDSA, the storage device may verify the first signature based on the first cryptographic algorithm.

When it is determined in operation S230 that the verification is successful, the flow proceeds to operation S240 in which the storage device may write the second public key in a memory to update the second public key to the storage device. Alternatively, when it is determined in operation S230 that the verification has failed, the flow proceeds to operation S250 in which the storage device may discard signed firmware.

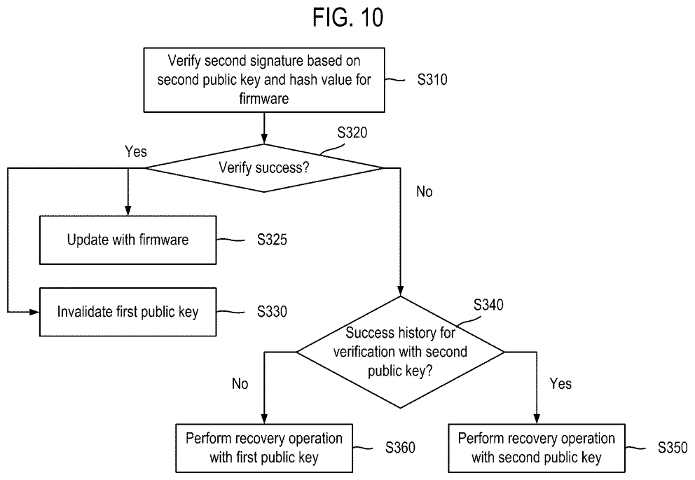

FIG. 10 is a flowchart illustrating a method of verifying firmware of a storage device according to example implementations.

Referring to FIG. 10, in operation S310, the storage device may verify a second signature based on a second public key and a hash value of firmware. A second cryptographic algorithm may be used to verify the second signature.

In operation S320, the storage device determines whether the verification is successful.

In some implementations, when the storage device uses hash-based cryptography such as LMS, XMSS, or HSS as the second cryptographic algorithm, the storage device may verify the second signature based on a one-time signature OTS and a Merkle tree structure. For example, the storage device may verify the OTS in a second signature based on a hash value of firmware. When the OTS is valid, the storage device may obtain a hash value of a leaf node of the Merkle tree corresponding to the OTS. The storage device may obtain a root hash value through the hash value of the leaf node and finally verify the second signature through the root hash value. For example, when the root hash value matches the second public key, the verification may be determined to be successful.

When it is determined in operation S320 that the verification is successful, the flow proceeds to operation S325 in which the storage device may update previously installed firmware to new firmware. After successful verification, the flow proceeds to operation S330 in which the storage device may invalidate the first public key.

Alternatively, when it is determined in operation S320 that the verification has failed, the flow proceeds to operation S340 in which the storage device may determine whether there is a history of successful verification based on the second public key.

When it is determined in operation S340 that there is a history of successful verification, the flow proceeds to operation S350 in which the storage device may perform recovery an operation, such as firmware rollback, recovery, or initialization, based on the second public key. Alternatively, when it is determined that there is no history of successful verification, the flow proceeds to operation S360 in which the storage device may perform a recovery operation based on the first public key.

For example, when the verification of the second signature fails, the storage device may determine a public key to be used for the recovery operation depending on whether there is a history of successful verification based on the second public key (for example, the second cryptographic algorithm). When there is no history of successful verification due to failure of verification through the second cryptographic algorithm, it indicates that the second public key is problematic. Consequently, the storage device may perform a recovery operation using the first public key.

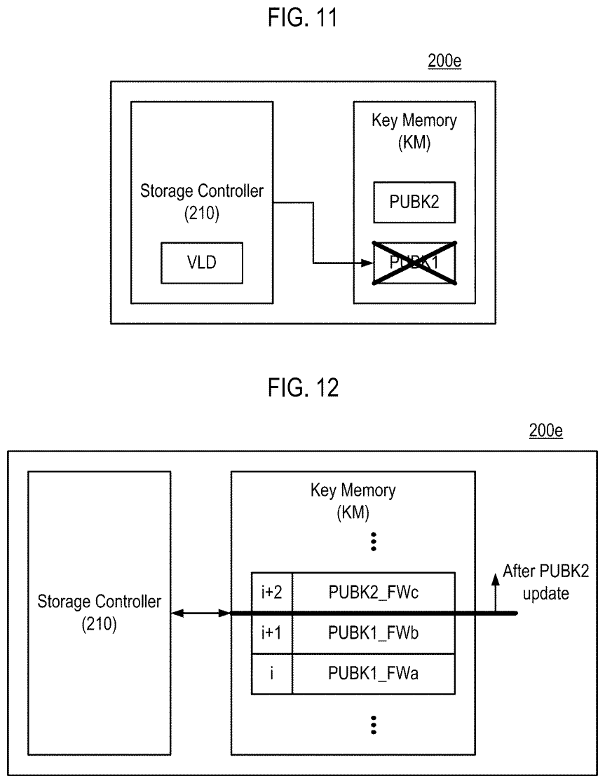

FIG. 11 is a diagram illustrating a storage device and a first public key invalidation operation according to example implementations.

Referring to FIG. 11, a storage controller 210 of a storage device 200e according to the above-described implementations may generate validity information VLD when verification of a second signature is successful through a second public key PUBK2 and a second cryptographic algorithm. When the validity information VLD is generated or when the verification of the second signature is successful, the storage controller 210 may access a key memory KM and invalidate a first public key PUBK1 stored in the key memory KM.

In some implementations, the key memory KM may include an OTP memory. The storage controller 210 may change one or more bits corresponding to a first logic level, among a plurality of bits included in the first public key PUBK1, to a second logic level based on the verification of the second signature being successful. For example, although OTP memory allows a specific logic level (for example, logic low) of data written once in the OTP memory to be changed to another logic level (for example, logic high), the reverse change is not allowed.

Therefore, the storage controller 210 may change all bits having a first logic level (for example, logic low), among bits constituting the first public key PUBK1, to a second logic level (for example, logic high) to invalidate a prestored first public key PUBK1 depending on whether the verification of the second signature is successful. All bits of the first public key PUBK1 have the second logic level, so that the first public key PUBK1 may be considered as data that can no longer be used, such as invalidated data.

Alternatively, the storage controller 210 may invalidate the first public key PUBK1 stored in the key memory KM in various other ways. When the key memory KM includes a memory that is able to change stored data, the storage controller 210 may erase the first public key PUBK1.

Alternatively, in some implementations, the storage controller 210 may transmit the validity information VLD to the host. When receiving the validity information VLD, the host may transmit a discard request command for the first public key PUBK1 to the storage controller 210. The storage controller 210 may invalidate the first public key PUBK1 in the key memory KM based on receiving the discard request command.

The above-described storage device 200e may invalidate the first public key PUBK1 when the verification of the second signature is successful, thereby preventing firmware verification using the first encryption algorithm.

FIG. 12 is a diagram illustrating a storage device and a public key storage operation according to example implementations.

Referring to FIG. 12, the storage controller 210 of the storage device 200e according to example implementations may sequentially write one or more first public keys PUBK1 and one or more second public keys PUBK2 in the key memory KM by index. For example, the storage controller 210 may write the second public key PUBK2 in a second index having a value greater than the first index at which the first public key PUBK1 is stored. Accordingly, the key memory KM may sequentially store the first public key PUBK1 and the second public key PUBK2 from a low index.

The one or more first public keys PUBK1 and the one or more second public keys PUBK2 may correspond to other versions of firmware. For example, the key memory KM may store the first public key PUBK1_FWa corresponding to firmware FWa at an i-th index in the key memory KM and store the first public key PUBK1_FWb corresponding to firmware FWb at an (i+1)-th index. When the update of the second public key PUBK2 is successful, the storage controller 210 may write the second public key PUBK2_FWc corresponding to firmware FWc in an (i+2)-th index.

In some implementations, an update to firmware and a public key corresponding to a relatively lower index, with respect to a specific index in the key memory KM, may be prevented. For example, an update from firmware FWb to firmware FWc may be performed, while an update from firmware FWb to firmware FWa may be prevented. As a result, public keys corresponding to lower indices, with respect to a specific index, may be effectively invalidated.

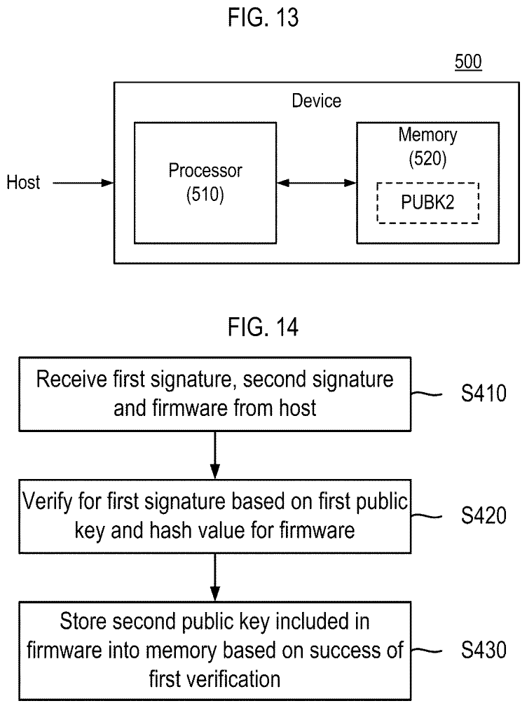

FIG. 13 is a diagram illustrating a device according to example implementations.

Referring to FIG. 13, a device 500 according to example implementations may include a processor 510 and a memory 520.

The processor 510 may be configured to perform the firmware verification operations according to the above-described implementations. In some implementations, the processor 510 may be included in the above-described storage controller or may be additionally provided within the storage device 500 to verify firmware based on a cryptographic algorithm.

The memory 520 may store a first public key and/or a second public key PUBK2 for the firmware verification operations according to the above-described implementations. In some implementations, the memory 520 may correspond to a key memory within the above-described storage device 500, or may be additionally provided within the storage controller, or may be additionally provided within the storage device 500.

In some implementations, the processor 510 may receive a first signature, a second signature, and firmware from a host and verify the first signature based on a first public key and a hash value of the firmware. The processor 510 may verify the first signature using a first cryptographic algorithm. The processor 510 may write a second public key PUBK2, included in the firmware, in the memory 520 based on the verification of the first signature being successful.

The processor 510 may verify the second signature based on the second public key PUBK2 written in the memory 520 and the hash value of the firmware after successful verification of the first signature.

The processor 510 may update previously installed firmware to new firmware based on the verification of the second signature being successful. Alternatively, the processor 510 may perform a recovery operation based on the first public key, based on the verification of the second signature failing. For example, when the first verification of the second signature fails, the processor 510 may perform a recovery operation using a pre-injected first public key rather than a second public key PUBK2 written in the memory 520.

In some implementations, the processor 510 may receive new signed firmware (for example, another version of firmware and the second signature) from the host after updating to the new firmware. The processor 510 may obtain a hash value of another version of the firmware and verify the second signature based on the second public key PUBK2 written in the memory 520 and the hash value of another version of the firmware.

When the verification of the second signature is successful, the processor 510 completes the update to another version of the firmware. Alternatively, when the second signature verification fails, the processor 510 may perform a recovery operation based on the second public key PUBK2. For example, when the verification of the second signature is successful at least once, the processor 510 may perform the recovery operation using the second public key PUBK2.

As a result, the device 500 according to the above-described implementations may update the second public key PUBK2, included in the firmware received from the host, to the memory 520 to switch a cryptographic algorithm used for firmware verification.

FIG. 14 is a flowchart illustrating a method of operating a device according to example implementations.

Referring to FIG. 14, in operation S410, a device may receive a first signature, a second signature, and firmware from a host.

In operation S420, the device may verify the first signature based on a first public key for decrypting the first signature and a hash value of the firmware. According to some implementations, the device may further perform an operation of inputting the firmware to a hash algorithm to obtaining the hash value.

In operation S430, the device may write a second public key, included in the firmware, in a memory based on the verification of the first signature being successful in operation S420.

Through the method of operating the device, including operations S410 to S430, the public key for a new cryptographic algorithm may be updated on the device.

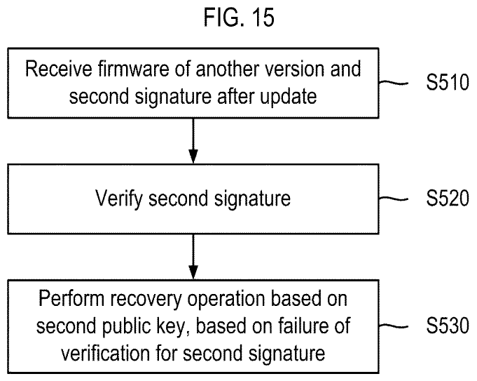

FIG. 15 is a flowchart illustrating a method of operating a device according to example implementations.

Referring to FIG. 15, in operation S510, after updating the signed firmware including the first signature and the second signature, the device may receive another version of the firmware and the second signature from the host.

In operation S520, the device may verify the second signature based on a second public key written in the memory and a hash value of another version of the firmware.

In operation S530, when the verification in operation S520 fails, the device may perform a recovery operation based on the second public key. For example, when the verification of the second signature for the firmware before another version of the firmware is successful, the device may use the second public key for the recovery operation when a subsequent verification fails.

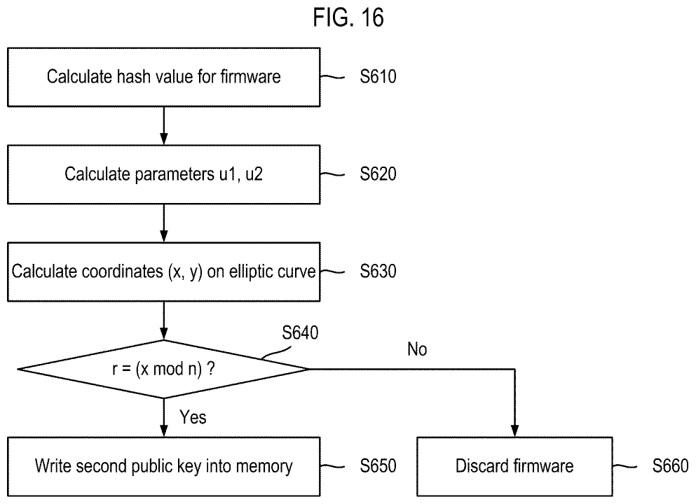

FIG. 16 is a flowchart illustrating a method of verifying a first signature and updating a public key of a device according to example implementations.

Referring to FIG. 16, in operation S610, the device may calculate a hash value of firmware. In operation S620, the device may calculate parameters u1 and u2 based on a modular inverse of the first signature and the hash value. For example, u1 is defined by an n-modular operation on the product of the hash value and the modular inverse (where n is the order of an elliptic curve), and u2 may be defined by an n-modular operation on the product of the first signature and the modular inverse. In operation S630, the device calculates coordinates (x, y) on the elliptic curve based on u1, u2, and the second public key. In operation S640, the device may determine whether x mod n matches r.

When x mod n matches r, the flow proceeds to operation S650 in which the device may determine that the verification of the first signature is successful and write the second public key in a memory.

When x mod n does not match r, the flow proceeds to operation S660 in which the device may discard the firmware.

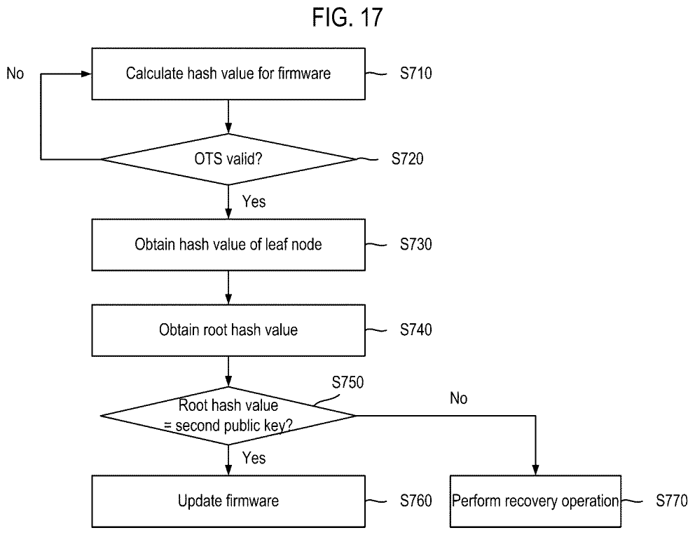

FIG. 17 is a flowchart illustrating a method of verifying a second signature of a device according to example implementations.

Referring to FIG. 17, in operation S710, the device calculates a hash value of firmware. In operation S720, the device may verify OTS in a second signature based on the hash value.

When the OTS is valid, the flow proceeds to operation S730 in which the device may obtain a hash value of a leaf node of a Merkle tree corresponding to the OTS. When the OTS is invalid, the device may perform operation S710 on different firmware. In operation S740, the device may obtain a root hash value of the Merkle tree from the hash value of the leaf node. In operation S750, the device may determine whether the root hash value matches a second public key.

When the root hash value matches the second public key, the flow proceeds to operation S760 in which the device may determine that the verification of the second signature is successful and update the firmware.

When the root hash value does not match the second public key, the flow proceeds to operation S770 in which the device may perform a recovery operation.

As set forth above, according to example embodiments, a device, a storage device, and a method for switching an encryption algorithm may be provided.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. A device comprising:
a memory; and
a processor configured to:
receive, from a host, a first signature that is based on a first cryptographic algorithm, a second signature that is based on a second cryptographic algorithm, and firmware;
verify the first signature based on a first public key for decrypting the first signature and a hash value associated with the firmware; and
write, in response to successful verification of the first signature, a second public key that is included in the firmware into the memory.

2. The device of claim 1, wherein
the processor is configured to verify the first signature based on the first cryptographic algorithm for the first public key and the hash value.

3. The device of claim 1, wherein
the processor is configured to:
verify the second signature based on the second public key that is written in the memory and the hash value; and
update previously installed firmware to the received firmware in response to successful verification of the second signature.

4. The device of claim 3, wherein
the processor is configured to verify the second signature based on the second cryptographic algorithm for the second public key and the hash value.

5. The device of claim 3, wherein
the processor is configured to invalidate the first public key in response to successful verification of the second signature.

6. The device of claim 1, wherein
the memory is a one-time programmable (OTP) memory.

7. The device of claim 6, wherein
the memory is configured to store the first public key, the first public key including a plurality of bits, and
the processor is configured to:
verify the second signature based on the second public key that is written in the memory and the hash value; and
change, in response to successful verification of the second signature, one or more bits of the plurality of bits of the first public key from a first logic level to a second logic level.

8. The device of claim 6, wherein
the memory stores the first public key at a first index, and
the processor is configured to write the second public key at a second index having a greater value than the first index.

9. The device of claim 1, wherein
the first cryptographic algorithm is an elliptic curve digital signature algorithm (ECDSA), and
the second cryptographic algorithm is Leighton-Micali Hash-Based signatures (LMS) algorithm.

10. The device of claim 1, wherein
the processor is configured to, in response to unsuccessful verification of the first signature, discard the first signature, the second signature, and the firmware.

11. The device of claim 3, wherein
the processor is configured to, in response to unsuccessful verification of the second signature, perform a recovery operation based on the first public key.

12. The device of claim 3, wherein
the processor is configured to:
after updating the previously installed firmware to the received firmware, receive, from the host, another version of the firmware and the second signature;
verify the second signature based on the second public key and a hash value associated with the another version of the firmware; and
perform, in response to unsuccessful verification of the second signature for the another version of the firmware, a recovery operation based on the second public key.

13. A storage device comprising:
a non-volatile memory configured to store a first signature that is based on a first cryptographic algorithm, a second signature that is based on a second cryptographic algorithm, and firmware; and
a storage controller configured to
verify the first signature based on a first public key for decrypting the first signature and a hash value associated with the firmware, and
update, in response to successful verification of the first signature, a second public key that is included in the firmware into the storage device.

14. The storage device of claim 13, further comprising:
a key memory configured to store the second public key.

15. The storage device of claim 14, wherein
the storage controller is configured to write the second public key in the key memory in response to successful verification of the first signature.

16. A method of operating a device, the method comprising:
receiving, from a host, a first signature generated based on a first cryptographic algorithm, a second signature generated based on a second cryptographic algorithm, and firmware;
verifying the first signature based on a first public key for decrypting the first signature and a hash value associated with the firmware; and
writing, in response to successful verification of the first signature, a second public key that is included in the firmware into a memory.

17. The method of claim 16, further comprising:
verifying the second signature based on the second public key that is written in the memory and the hash value; and
updating previously installed firmware to the received firmware in response to successful verification of the second signature.

18. The method of claim 17, further comprising:
invalidating the first public key in response to successful verification of the second signature.

19. The method of claim 17, further comprising:
performing, in response to unsuccessful verification of the second signature, a recovery operation based on the first public key.

20. The method of claim 17, further comprising:
after updating the previously installed firmware to the received firmware, receiving, from the host, another version of the firmware and the second signature;
verifying the second signature based on the second public key that is written in the memory and a hash value associated with the another version of the firmware; and
performing, in response to unsuccessful verification of the second signature for the another version of the firmware, a recovery operation based on the second public key.
